(19) United States
(12) Patent Application Publication
(10) Pub. No.: US 2026/0335804 A1
(43) Pub. Date: Oct. 29, 2026

(54) APPARATUS AND METHODS FOR COLLAPSIBLE MULTI-PANEL AIR FILTER

(71) Applicant: K&N Engineering, Inc., Corona, CA (US)

(72) Inventors: Steve Williams, Cherry Valley, CA (US); Jere James Wall, Helendale, CA (US)

(73) Assignee: K&N Engineering, Inc., Corona, CA (US)

(21) Appl. No.: 19/727,343

(22) Filed: Jul. 1, 2026

Related U.S. Application Data
(63) Continuation-in-part of application No. 17/831,820, filed on Jun. 3, 2022.
Application No. 17/831,820 is a continuation-in-part of application No. 16/579,645, filed on Sep. 23, 2019, now Pat. No. 11,241,647.
Application No. 16/579,645 is a continuation of application No. 15/288,473, filed on Oct. 7, 2016, now Pat. No. 10,512,872.
Application No. 15/288,473 is a continuation of application No. 15/207,025, filed on Jul. 11, 2016, now Pat. No. 10,632,411.
Application No. 15/207,025 is a continuation-in-part of application No. 14/974,092, filed on Dec. 18, 2015, now Pat. No. 10,434,466.
Application No. 14/974,092 is a continuation-in-part of application No. 14/668,772, filed on Mar. 25, 2015, now Pat. No. 9,701,178.
(63) Continuation of application No. 19/350,956, filed on Oct. 6, 2025.
(60) Provisional application No. 63/171,357, filed on Apr. 6, 2021.
(60) Provisional application No. 63/252,351, filed on Oct. 5, 2021.
(60) Provisional application No. 63/704,422, filed on Oct. 7, 2024.

(51) Int. Cl. B01D 46/10; B01D 39/08; B01D 41/04; B01D 46/00; B01D 46/52; B01D 46/66; F24F 8/108; F24F 8/192

(52) U.S. Cl. CPC B01D 46/10; B01D 39/083; B01D 39/086; B01D 41/04; B01D 46/0005; B01D 46/0028; B01D 46/0032; B01D 46/0035; B01D 46/0038; B01D 46/0097; B01D 46/521; B01D 46/66; F24F 8/108; F24F 8/192; B01D 2279/50

(57) ABSTRACT

An apparatus and methods are provided for a reusable multi-panel air filter to remove contaminants from air within interior building environments. The multi-panel air filter comprises a multiplicity of reusable filter panels for filtering an airstream. The filter panels can be cleaned by removing them from the multi-panel air filter, flushing contaminants from the filter panels, and allowing the filter panels to dry. The filter panels include a compound filter medium between wire screens that are co-pleated with the filter medium. The compound filter medium includes hydrophobic pre-filter layers that provide structural protection to the compound filter medium during flushing contaminants with water. The hydrophobic pre-filter layers comprise a spunbond polyester material that is durable, washable, and is highly resistant to moisture, chemicals, and abrasion. The compound filter medium includes hydrophobic efficiency layers that filter specific particle sizes, ranging from large dust to microscopic contaminants while offering low airflow resistance.

### PRIORITY

This application is a continuation-in-part of U.S. patent application Ser. No. 17/831,820, filed on Jun. 3, 2022, which is a continuation-in-part of U.S. patent application Ser. No. 16/579,645, filed Sep. 23, 2019, which is a continuation of U.S. patent application Ser. No. 15/288,473, filed Oct. 7, 2016, which is a continuation of U.S. patent application Ser. No. 15/207,025, filed Jul. 11, 2016, which is a continuation-in-part of U.S. patent application Ser. No. 14/974,092, filed Dec. 18, 2015, now issued U.S. Pat. No. 10,434,466, which is a continuation-in-part of U.S. patent application Ser. No. 14/668,772, filed Mar. 25, 2015, now issued U.S. Pat. No. 9,701,178. This application also claims the benefit of and priority to U.S. Provisional Application, entitled “Multi-Panel Air Filter,” filed on Apr. 6, 2021, and having application Ser. No. 63/171,357; and also claims the benefit of and priority to U.S. Provisional Application, entitled “Multi-Panel Air Filter,” filed on Oct. 5, 2021, and having application Ser. No. 63/252,351. This application also claims the benefit of U.S. patent application Ser. No. 19/350,956, filed on Oct. 6, 2025, which claims the benefit of and priority to U.S. Provisional Application, filed on Oct. 7, 2024, and having application Ser. No. 63/704,422. The entirety of each of said applications is incorporated herein by reference.

### FIELD

Embodiments of the present disclosure generally relate to the field of filter devices. More specifically, embodiments of the disclosure relate to an apparatus and methods for a reusable modular multi-panel air filter comprising compound media configured to resist damage to pleats and reduced performance of the air filter due to periodic washing and reuse so as to preserve an optimal filtration efficiency.

### BACKGROUND

Heating, ventilation, and air conditioning (HVAC) systems generally operate to provide optimal indoor air quality to occupants within interior building spaces. HVAC systems achieve optimal indoor air quality by conditioning air, removing particle contaminants by way of ventilation and filtration of air, and providing proper building pressurization.

While there are many different HVAC system designs and operational approaches, and each building design is unique, HVAC systems generally share a few basic design elements. For example, outside air (“supply air”) generally is drawn into a HVAC system of a building through an air intake. Once in the HVAC system, the supply air is filtered to remove particle contaminants, then heated or cooled, and then circulated throughout the building by way of an air distribution system. Many air distribution systems comprise a return air system configured to draw air from interior building spaces and return the air (“return air”) to the HVAC system. The return air is then mixed with supply air and then filtered, conditioned, and circulated throughout the building. Often times, a portion of the air circulating within the building may be exhausted to the exterior of the building so as to maintain a desired barometric pressure within the building.

As will be appreciated, the effectiveness of the HVAC system to provide optimal indoor air quality depends largely on the ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. A drawback to conventional HVAC system air filters, however, is that highly effective air filters capable of removing very small contaminants, such as airborne molecular contaminants and volatile organic compounds (VOCs), tend to restrict airflow through the air filter, thereby making the HVAC system work harder and consume more energy.

Another drawback to conventional HVAC system air filters is that dirty or clogged air filters typically are removed from the HVAC system and discarded, and a new HVAC system air filter is then installed. Further, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is staggering.

A solution to the problem of unnecessarily discarding HVAC system air filters is to fabricate washable HVAC system air filters that can be periodically cleaned and reused. In general, a dirty reusable air filter can be removed from the from the HVAC system and then a water hose may be used to flush contaminants from the air filter, thereby leaving the filter clean and ready for reuse. Once the air filter has been sufficiently dried, the air filter can be reinstalled into the HVAC system. A drawback to washable HVAC system air filters is that washing and drying the air filter can degrade the ability of the air filter to remove contaminants from inflowing air. Another drawback is that pleats comprising the air filter can be deformed or damaged due to the force of water flushing contaminants from the air filter.

What is needed, therefore, is a reusable HVAC air filter that maintains an optimal filtration efficiency after being periodically washed and is capable of withstanding the forces encountered during washing the air filter with water.

### SUMMARY

An apparatus and methods are provided for a reusable multi-panel air filter to remove contaminants from air within interior building environments. The multi-panel air filter comprises a multiplicity of reusable filter panels for filtering an airstream. The filter panels can be cleaned by removing them from the multi-panel air filter, flushing contaminants from the filter panels, and allowing the filter panels to dry. The filter panels include a compound filter medium between first and second wire screens that are co-pleated with the filter medium. The compound filter medium includes one or more hydrophobic pre-filter layers that provide structural protection to the compound filter medium during flushing contaminants with water. The hydrophobic pre-filter layers are a spunbond polyester material that is durable, washable, and comprises a high-strength filter material that is highly resistant to moisture, chemicals, and abrasion. The compound filter medium includes hydrophobic efficiency layers that filter specific particle sizes, ranging from large dust to microscopic contaminants while offering low airflow resistance.

In an exemplary embodiment, an apparatus for a multi-panel air filter to clean air in interior building environments comprises: a multiplicity of reusable filter panels arranged into a V-bank filter element for filtering an airstream; a top end plate and a bottom end plate supporting the V-bank filter element; and a pleat channel supporting adjacent side edges of the filter panels comprising the V-bank filter element.

In another exemplary embodiment, the top end plate, the bottom end plate, and the pleat channels define openings that allow the airstream to pass through the V-bank filter element. In another exemplary embodiment, each of the top end plate and the bottom end plate includes a ledge portion and has a shape and a size configured to support the multi-panel air filter within the HVAC system. In another exemplary embodiment, a side rail comprises a pleat channel that includes a side ledge that is configured to be disposed along opposite sides of the multi-panel air filter. In another exemplary embodiment, the side rails and the ledge portions provide an uninterrupted ledge that is configured to orient the multi-panel air filter within the HVAC system.

In another exemplary embodiment, a gasket is incorporated into the uninterrupted ledge. In another exemplary embodiment, the gasket is incorporated directly into the uninterrupted ledge to eliminate a need for a separately provided gasket. In another exemplary embodiment, each of the ledge portions and the side rails includes a strip of material that operates as a gasket once the multi-panel air filter is assembled.

In another exemplary embodiment, the V-bank filter element comprises two or more filter panels that are angled with respect to one another to form one or more V-configurations. In another exemplary embodiment, each of the top end plate and the bottom end plate includes a seat that receives respective top and bottom edges of the filter panels, such that the filter panels are disposed in the V-configurations.

In another exemplary embodiment, the multiplicity of reusable filter panels are configured to be individually removed from the multi-panel air filter. In another exemplary embodiment, a first filter panel and an adjacent second filter panel can be accessed upon disengaging a corresponding pleat channel from the top end plate and the bottom end plate. In another exemplary embodiment, the first filter panel and the second filter panel can be slid out of the seats disposed in the top end plate and the bottom end plate. In another exemplary embodiment, the first filter panel and the second filter panel can be removed in a downstream direction after removing a downstream pleat channel from the multi-panel air filter. In another exemplary embodiment, the first filter panel and the second filter panel can be removed in an upstream direction after removing an upstream pleat channel from the multi-panel air filter.

In another exemplary embodiment, an upstream panel air filter is coupled with the multi-panel air filter. In another exemplary embodiment, the panel air filter comprises a primary filter while the multi-panel air filter comprises a secondary filter. In another exemplary embodiment, the primary filter is configured to extend the longevity of the secondary filter. In another exemplary embodiment, the primary filter has a lower MERV rating than the MERV rating of the secondary filter. In another exemplary embodiment, the primary filter is coupled with the secondary filter by way of a hinge and a clasp.

In an exemplary embodiment, a reusable multi-panel air filter for an HVAC system of a building comprises: a multiplicity of reusable filter panels arranged into a V-bank filter element for filtering an airstream; a top end plate supporting top edges of the filter panels; a bottom end plate supporting bottom edges of the filter panels; a telescoping pleat channel supporting adjacent side edges of the filter panels; and a telescoping side rail supporting opposite ends of the top end plate and the bottom end plate.

In another exemplary embodiment, the telescoping pleat channels and the telescoping side rails are configured to shorten when the top end plate and the bottom end plate are pressed toward one another, thereby decreasing a height dimension of the V-bank filter element. In another exemplary embodiment, the filter panels include pleats that are configured to collapse when the top end plate and the bottom end plate are pressed toward one another, thereby decreasing the height dimension of the V-bank filter element.

In another exemplary embodiment, the telescoping pleat channels and the telescoping side rails are configured to enable compressing the V-bank filter element into a smaller volume to reduce storage and shipping costs. In another exemplary embodiment, the telescoping pleat channels and the telescoping side rails are configured to enable expanding the V-bank filter element from a compressed configuration by pulling the top end plate and the bottom end plate in opposite directions to increase the lengths of the telescoping pleat channels and the telescoping side rails and stretch open pleats of the filter panels. In another exemplary embodiment, the telescoping pleat channels and the telescoping side rails are configured to lock at lengths that maintain an operational configuration of the V-bank filter element.

In another exemplary embodiment, the telescoping pleat channel is configured to be changed from a compressed configuration to an extended configuration. In another exemplary embodiment, the telescoping pleat channel comprises at least one upper portion that is concentric with at least one bottom portion. In another exemplary embodiment, the upper portion is configured to slide within an interior of the bottom portion.

In another exemplary embodiment, the telescoping pleat channel includes a lock configured to fixate the extended configuration of the telescoping pleat channel. In another exemplary embodiment, the extended configuration comprises a length of the telescoping pleat channel that maintains an operational configuration of the V-bank filter element. In another exemplary embodiment, the telescoping pleat channel is configured to be changed from the compressed configuration to the extended configuration by pulling the upper portion out of the interior of the bottom portion until the lock engages and fixates the extended configuration of the telescoping pleat channel.

In another exemplary embodiment, the telescoping side rail is configured to be changed from a compressed configuration to an extended configuration. In another exemplary embodiment, the telescoping side rail comprises at least one upper portion that is concentric with at least one bottom portion. In another exemplary embodiment, the upper portion is configured to slide within an interior of the bottom portion.

In another exemplary embodiment, the telescoping side rail includes a lock configured to fixate the extended configuration of the telescoping side rail. In another exemplary embodiment, the extended configuration comprises a length of the telescoping side rail that maintains an operational configuration of the V-bank filter element. In another exemplary embodiment, the telescoping side rail is configured to be changed from the compressed configuration to the extended configuration by pulling the upper portion out of the interior until the lock engages and fixates the extended configuration of the telescoping side rail.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary-use environment wherein a modular multi-panel air filter is incorporated into a HVAC system of a building, according to the present disclosure;

FIG. 2 illustrates a schematic view of an exemplary embodiment of a HVAC system comprising a modular multi-panel air filter in accordance with the present disclosure;

FIG. 3 illustrates an isometric view of an exemplary embodiment of a reusable modular multi-panel air filter that may be used to clean an airstream flowing through a HVAC system to clean air within interior building spaces;

FIG. 4 illustrates a cross-sectional view of the reusable modular multi-panel air filter of FIG. 3, taken along a line 4-4;

FIG. 5 illustrates an isometric exploded view of the reusable modular multi-panel air filter of FIG. 3, according to the present disclosure;

FIG. 6 illustrates an exemplary-use environment wherein dirty filter panels have been removed from a downstream side of a reusable modular multi-panel air filter for cleaning, according to the present disclosure;

FIG. 7 illustrates an exemplary-use environment wherein dirty filter panels have been removed from an upstream side of a reusable modular multi-panel air filter for cleaning in accordance with the present disclosure;

FIG. 8 illustrates a cross-sectional view of an exemplary embodiment of a reusable modular multi-panel air filter that is coupled with an upstream, primary air filter, according to the present disclosure;

FIG. 9 illustrates a cross-sectional view of an exemplary embodiment of a compound filter medium that is co-pleated with supportive wire screens in accordance with the present disclosure.

FIG. 10 illustrates an exemplary embodiment of a modular multi-panel air filter configured to be compressed for shipping in accordance with the present disclosure;

FIG. 11 illustrates an exemplary embodiment of a packaging configuration for upstream vertical members comprising the modular multi-panel air filter of FIG. 10 according to the present disclosure;

FIG. 12 illustrates an exemplary embodiment of a packaging configuration for downstream vertical members comprising the modular multi-panel air filter of FIG. 10 according to the present disclosure;

FIG. 13 illustrates an exemplary embodiment of a packaging configuration of the modular multi-panel air filter of FIG. 10 and the vertical members shown in FIGS. 11-12 in accordance with the present disclosure;

FIG. 14 illustrates an exemplary embodiment of a compressible multi-panel air filter according to the present disclosure;

FIG. 15A illustrates an exemplary embodiment of a telescoping pleat channel in a compressed configuration in accordance with the present disclosure;

FIG. 15B illustrates the telescoping pleat channel of FIG. 15A in an extended configuration according to the present disclosure;

FIG. 15C illustrates a close-up cross-sectional view of an exemplary embodiment of a lock configured to fixate the extended configuration of the telescoping pleat channel according to the present disclosure;

FIG. 16A illustrates an exemplary embodiment of a telescoping side rail in a compressed configuration in accordance with the present disclosure; and

FIG. 16B illustrates the telescoping side rail of FIG. 16A in an extended configuration according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the reusable modular multi-panel air filter and methods disclosed herein may be practiced without these specific details. In other instances, specific numeric references such as “first filter,” may be made. However, the specific numeric reference should not be interpreted as a literal sequential order but rather interpreted that the “first filter” is different than a “second filter.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, dirty or clogged conventional HVAC system air filters must be removed from HVAC systems and discarded, and new HVAC system air filters must be installed. Considering that there are millions of buildings with HVAC systems throughout the world, the volume of discarded air filters that could be eliminated from landfills is a staggering number. A solution to the problem of unnecessarily discarding HVAC system air filters is to fabricate washable HVAC system air filters that can be periodically cleaned and reused. A drawback to washable HVAC system air filters, however, is that washing and drying the air filter can degrade the ability of the air filter to remove contaminants from inflowing air. Another drawback is that pleats of the air filter can be deformed or damaged due to the force of water flushing contaminants from the air filter. Embodiments described herein provide compound media and methods for a reusable modular multi-panel air filter configured to resist damage to pleats and reduced filtration efficiencies arising due to periodic washing and reuse.

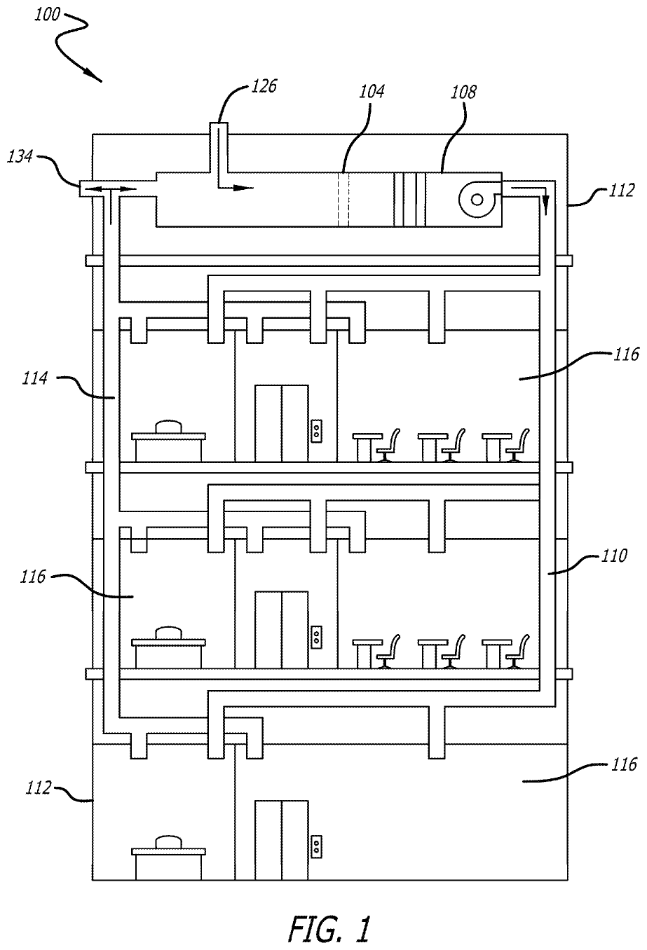

FIG. 1 illustrates an exemplary-use environment 100 wherein an air filter 104 is incorporated into a HVAC system 108 of a building 112 to clean an airstream drawn through the air filter 104. Although the building 112 illustrated in FIG. 1 comprises a multi-story office building, it should be understood that the building 112 may comprise any of various structures, such as warehouses, storage spaces, server rooms, clean rooms, office spaces, residential homes, apartments, condominiums, and the like, without limitation. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which stores including one or more building spaces 116, as illustrated in FIG. 1, or may comprise a single-story building, including but not limited to a detached residential home.

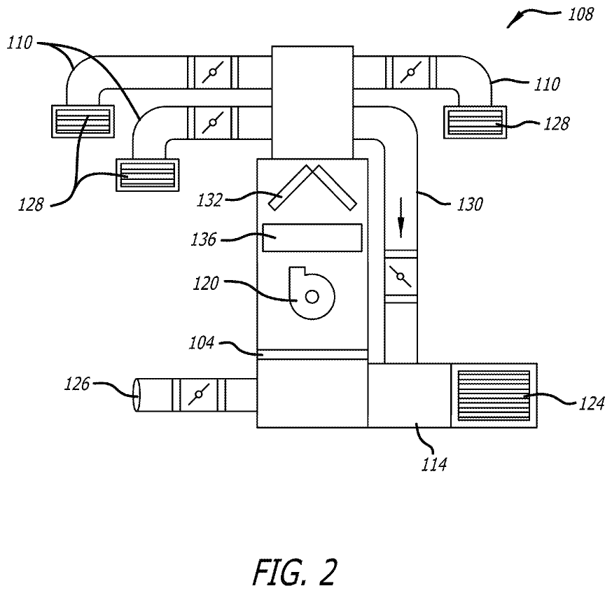

FIG. 2 illustrates a schematic view of an exemplary embodiment of a HVAC system 108 that may be used to clean air within building spaces 116. The HVAC system 108 generally comprises a fan 120 configured to draw a return airstream 124 from the building spaces 116 through the air filter 104 whereby airborne molecular contaminants, VOCs, and other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 airstream so as to maintain a desired barometric pressure within the HVAC system 108 and within the building spaces 116. In some embodiments, an exhaust airstream 134 (see FIG. 1) may be further incorporated into the HVAC system 108 to maintain the desired barometric pressure and to allow entry of the outside airstream 126.

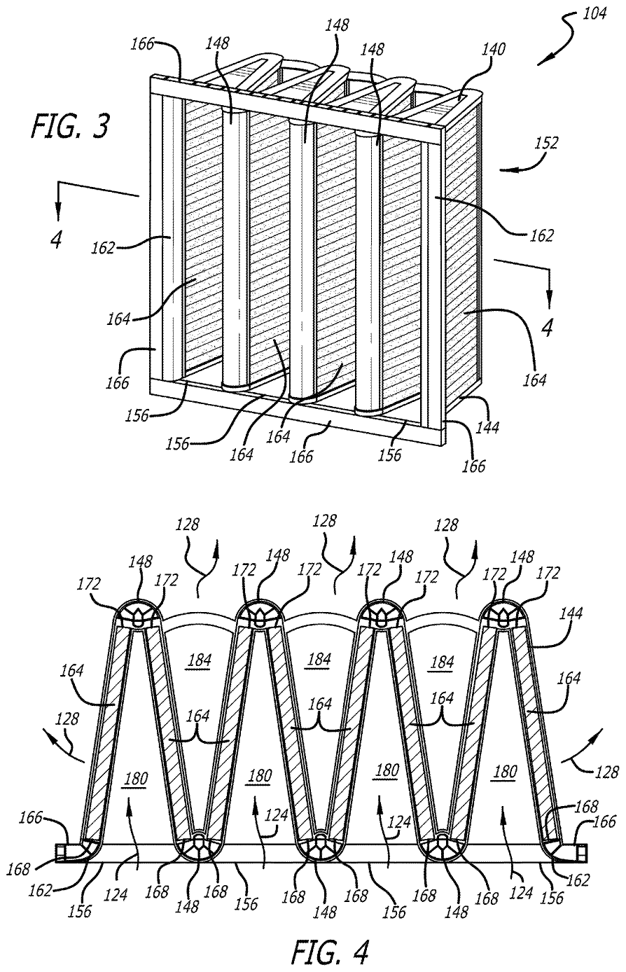

FIG. 3 illustrates an exemplary embodiment of a reusable modular multi-panel air filter 104 according to the present disclosure. The reusable modular multi-panel air filter 104 (hereinafter, “MPF 104”) generally is a V-bank variety of air filter, which comprises a class of filters also referred to as rigid pocket filters. V-bank filters often comprise an important element in clean room environments. V-bank filters may be implemented as pre-filters before HEPA filters, for example. The ‘V’ configuration provides more surface area than traditional filters, reduces an overall pressure drop in the HVAC system 108, and extends the usable life of downstream filters.

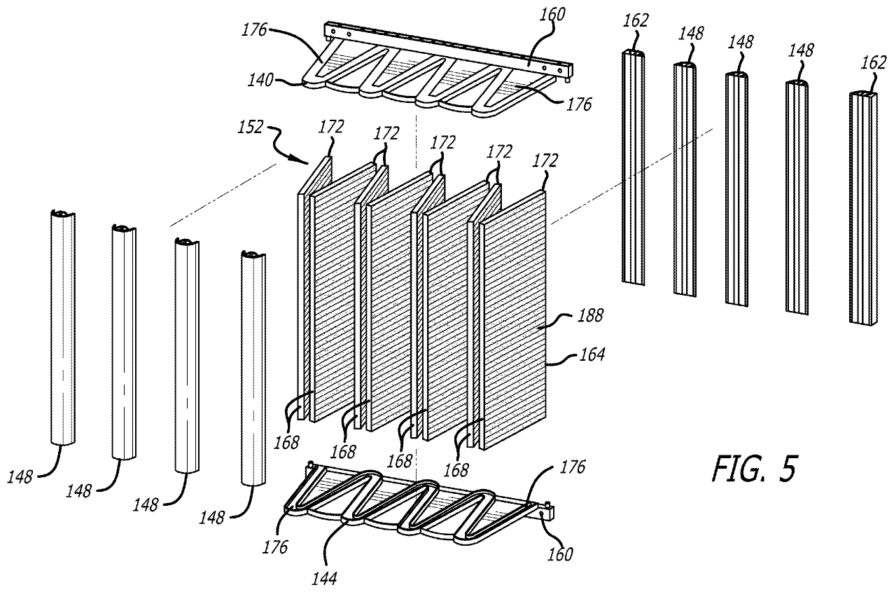

As shown in FIG. 3, the MPF 104 broadly comprises a top end plate 140, a bottom end plate 144, and multiple pleat channels 148 disposed vertically between the top and bottom end plates 140, 144. The top and bottom end plates 140, 144 and the pleat channels 148 support a V-bank filter element 152 and provide structural rigidity to the MPF 104. The top and bottom end plates 140, 144 and the pleat channels 148 are configured to orient the MPF 104 within the HVAC system 108 such that the return airstream 124 is directed through the V-bank filter element 152. As such, the top and bottom end plates 140, 144 and the pleat channels 148 define openings 156 that allow the return airstream 124 to pass through the V-bank filter element 152. In some embodiments, such as the embodiment shown in FIG. 5, the top and bottom end plates 140, 144 each provide a ledge portion 160 and has a shape and a size configured to support the MPF 104 within the HVAC system 108.

Moreover, in the illustrated embodiment shown in FIG. 5, a pleat channel that includes a side ledge (hereinafter, “side rail 162”) is disposed between the end plates 140, 144 along opposite sides of the MPF 104. The side rails 162 and the ledge portions 160 disposed on the top and bottom end plates 140, 144 provide an uninterrupted ledge 166 that extends around the openings 156, as shown in FIG. 3. The uninterrupted ledge 166 is configured to orient the MPF 104 within the HVAC system 108. As such, the top and bottom end plates 140, 144, the pleat channels 148, and the side rails 162 may be formed of any rigid material capable of supporting the MPF 104 within the HVAC system 108. It should be understood that the dimensions of the uninterrupted ledge 166 may be varied to accommodate the make and model of the HVAC system 108 for which the MPF 104 is intended to be used.

In some embodiments, a gasket may be incorporated into the MPF 104 to prevent the return airstream 124 from flowing around the uninterrupted ledge 166 and thus bypassing the V-bank filter element 152. For example, in some embodiments, a gasket may be configured to be disposed between the uninterrupted ledge 166 and an interior of the HVAC system 108. In some embodiments, the gasket may be incorporated directly into the uninterrupted ledge 166 to eliminate a need for a separately provided gasket. Thus, the ledge portions 160 of the top and bottom end plates 140, 144, and the side rails 162 may each include a strip of material that can operate as a gasket once the MPF 104 is assembled as shown in FIG. 3. As will be appreciated, the strips can be disposed on the ledge portions 160 and the side rail 162 such that the strips form a continuous strip of gasket material that extends around the uninterrupted ledge 166 once the MPF 104 is assembled. It is contemplated that the strip of gasket material may comprise any material that is amenable to providing an airtight seal between the uninterrupted ledge 166 and the interior of the HVAC system 108, without limitation.

In general, the V-bank filter element 152 comprises two or more filter panels 164 that are angled with respect to one another to form one or more ‘V’-configurations. As best shown in FIG. 4, the filter panels 164 are arranged into adjacent V-configurations wherein front edges 168 of each pair of adjacent filter panels 164 are engaged with a shared pleat channel 148. Similarly, rear edges 172 of each pair of adjacent filter panels 164 are engaged with a shared pleat channel 148. Further, each of the top and bottom end plates 140, 144 includes a seat 176 (see FIG. 5) that receives respective top and bottom edges of the filter panels 164, such that the filter panels 164 are disposed in the V-configurations shown in FIG. 4. The V-configurations may be viewed as defining upstream and downstream volumes. For example, each of the openings 156 allows the return airstream 124 to enter an upstream volume 180 between adjacent V-configurations of the filter panels 164. Upon passing through the filter panels 164, a clean airstream 128 exits the MPF 104 through a downstream volume 184 disposed between adjacent V-configurations of the filter panels 164.

Moreover, the seats 176 are configured to fixate the V-configurations of the filter panels 164 such that the upstream volumes 180 between adjacent V-configurations include substantially identical angles and areas. As such, the upstream volumes 180 are substantially identical to one another. Similarly, the seats 176 are configured such that the downstream volumes 184 between adjacent V-configurations include substantially identical angles and areas, and thus the downstream volumes 184 are substantially identical to one another. It is contemplated that the top and bottom end plates 140, 144 may be formed of any rigid material suitable for maintaining the configuration of the seats 176 and thus preserving the V-configurations of the filter panels 164 shown in FIG. 4.

Turning, now, to FIG. 5, the filter panels 164 each comprises a filter medium 188 that provides an area through which to pass the return airstream 124 and entrap particulates and other contaminates flowing with the airstream 124. The filter medium 188 may be formed of paper, foam, cotton, spun fiberglass, or other known filter materials, woven or non-woven material, synthetic or natural, or any combination thereof. The filter medium 188 may be pleated, or otherwise shaped, or contoured so as to increase the surface area for passing the return airstream 124 to be cleaned. Thus, the length of the filter medium 188 may be greater than the length of the filter panel 164 generally, due to the pleats, such that the surface area of the filter medium 188 is greater than the surface area of the filter panel 164.

In some embodiments, the filter medium 188 may be a composite filter medium comprising one or more media layers, each having unique filtration properties such that the combination of media layers exhibits a relatively high filtration efficiency and a relatively low air pressure drop across the filter medium 188. For example, in one embodiment, the filter medium 188 may comprise a first media layer and a second media layer. The first media layer may comprise a fiber density that is relatively lower than the fiber density of the second media layer. Thus, the filter medium 188 may comprise a fiber density that generally increases in the direction of air flow through the filter medium 188.

In some embodiments, the filter media 188 may comprise a dried synthetic material that generally becomes surface loaded as contaminants are deposited onto upstream surfaces of the filter media 188 during use of the MPF 104 in the HVAC system 108. As will be appreciated, the dried synthetic material may be cleaned by simply using a water hose to flush the contaminants from the filter media 188. In some embodiments, the filter media 188 may be cleaned by applying the water to downstream surfaces of the filter media 188 to dislodge the contaminants from the upstream surfaces of the filter media 188. In some embodiments, however, the filter media 188 may be cleaned by applying higher-pressure water to the upstream surfaces of the filter media 188 to flush the contaminants away from the filter media 188.

It is contemplated that a practitioner may periodically clean the filter medium 188 rather than replacing the entire MPF 104, as is typically done with conventional air filter systems. As described herein, it is envisioned that the MPF 104 can be serviced by removing individual filter panels 164 from the MPF 104 without having to remove the entire MPF 104 from the HVAC system 108. Filter panels 164 can be cleaned by using a water hose to flush contaminants from the filter medium 188 of the filter panel 164 and then allowing the filter medium 188 to dry. Clean filter panels 164 can be installed into the MPF 104 immediately after removing the dirty filter panels 164 so as to maintain filtration of the return airstream 124 during cleaning and drying the dirty filter bags 164. In some embodiments, however, the entire MPF 104 can be removed from the HVAC system 108 to enable removing any trapped debris from the HVAC system 108.

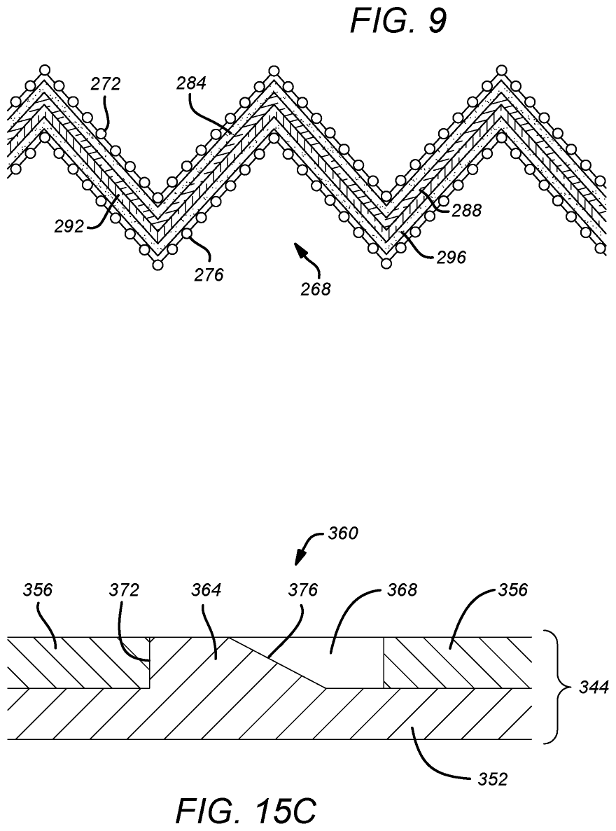

In some embodiments, the filter medium 188 may comprise a compound filter medium 268 that is co-pleated with a first screen 272 and a second screen 276, as shown in FIG. 9, that may be incorporated into reusable filter panels 164. The first and second screens 272, 276 can be made of any material capable of being co-pleated with the pleats comprising the compound filter medium 268 and withstanding forces encountered by the pleats during washing the compound filter medium 268, as described herein. In some embodiments, the first and second screens 272, 276 may comprise nylon. In some embodiments, the first and second screens 272, 276 may comprise a rigid material, such as, by way of non-limiting example, any of various suitable plastics or metals. For example, in some embodiments, either or both of the first and second screens 272, 276 may be comprised of powder-coated aluminum screen wire that is co-pleated along with the compound filter medium 268 so as to reinforce the reusable filter panel 164.

As shown in FIG. 9, the compound filter medium 268 comprises a combination of one or more media layers, each having unique properties. The combination of one or more media layers can be configured to exhibit a relatively high filtration efficiency, ranging between MERV 11 and MERV 16, and a relatively low air pressure drop across the compound filter medium 268. In some embodiments, the combination of one or more media layers comprises a first media layer 284, a second media layer 288, a third media layer 292, and a fourth media layer 296. In an embodiment, the second media layer 288 and the third media layer 292 may comprise hydrophobic efficiency layers configured to trap, capture, or filter out specific particle sizes, ranging from large dust to microscopic contaminants while offering low airflow resistance. In some embodiments, the second media layer 288 and/or the third media layer 292 may include electrostatic, triboelectric, or nanofiber technologies to maximize capture.

The first media layer 284 may comprise a hydrophobic pre-filter layer that provides structural protection to the second, third, and fourth media layers 288, 292, 296 during flushing contaminants from the second media layer 288 with water. In some embodiments, the first media layer 284 comprises a spunbond polyester material that is durable, washable, and comprises a high-strength filter material that is highly resistant to moisture, chemicals, and abrasion. Further, in some embodiments, the first media layer 284 and the fourth media layer 296 comprise spunbond polyester material layers that provide structural protection to the second and third media layers 288, 292 during flushing contaminants from the reusable filter panel 164.

In some embodiments, any one or more of the first, second, and third media layers 284, 288, 292 may include an electrostatic portion that is configured to electrostatically attract and agglomerate particle contaminants within the air flowing through the HVAC system 108. It is contemplated that the electrostatic portion may be comprised of at least some fibers that are treated with a coating of antimicrobial molecules configured to destroy microbes. In some embodiments, the antimicrobial molecules may be comprised of positively charged molecules distributed around a circumference of some fibers of the first, second, or third media layers 284, 288, 292 and configured to cooperate with polarized fibers disposed within the compound filter medium 268.

In some embodiments, at least some of the fibers comprising the fourth media layer 296 may be treated with a coating of antimicrobial molecules configured to destroy microbes on contact. Preferably, the coating of antimicrobial molecules surrounds substantially the entire circumference of each fiber strand that is treated. In some embodiments, substances configured to release a fragrance may be incorporated into the fourth media layer 296 comprising the antimicrobial molecules. It is contemplated that the fragrance may be any natural substance, synthetic material, (incorporating aldehydes, ketones, esters, and other chemical constituents), or combinations thereof, which is known in the art and suitable for use in candles for imparting an odor, aroma, or fragrance. In some embodiments, suitable natural and synthetic fragrance/flavor substances may include those compiled by the U.S. Food and Drug Administration in Title 21 of the Code of Federal Regulations, Sections 172.510 and 172.515 respectively. In some embodiments, suitable fragrances may comprise spice oil, flower oil, fruit oil, and the like. In some embodiments, suitable fragrances may comprise fragrance components, such as for example benzaldehydes, phenols, cinnamic aldehydes and esters, octadienes, dienes, cyclohexadienes, terpenes, and the like.

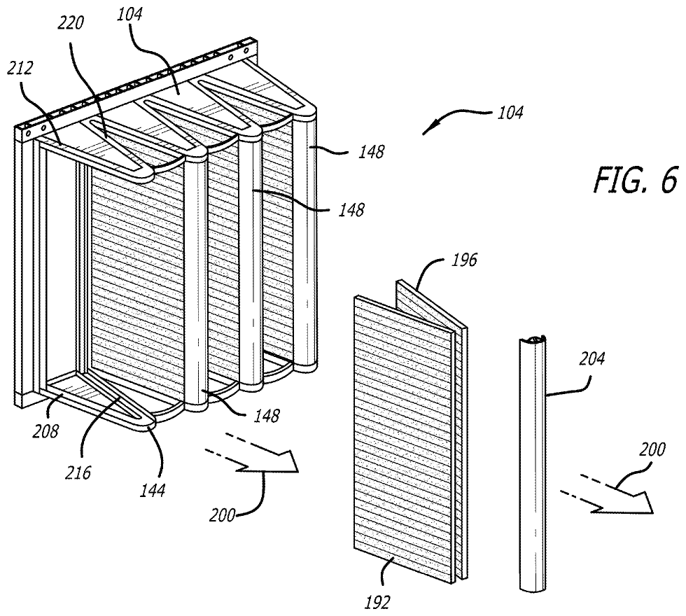

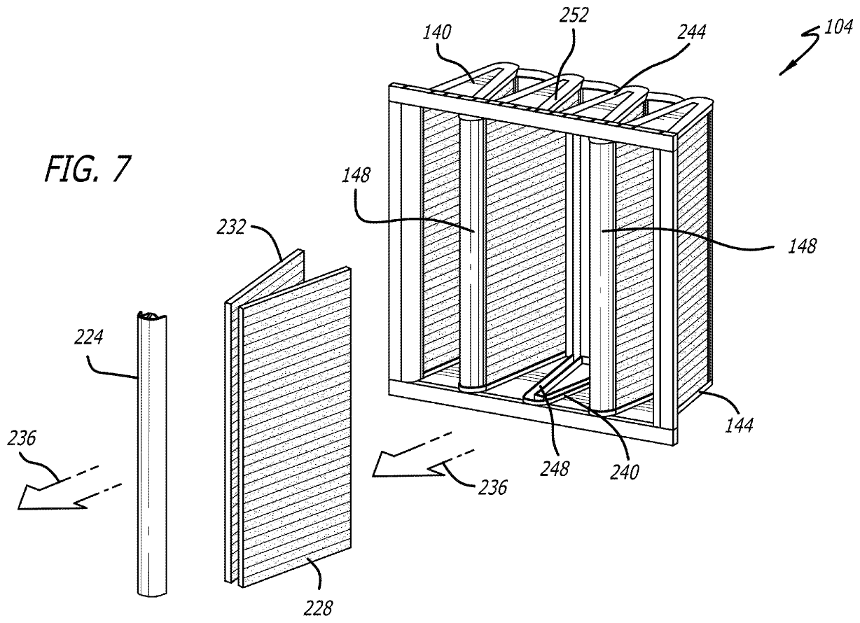

FIGS. 6-7 illustrate exemplary-use environments wherein dirty filter panels have been removed from the MPF 104 for cleaning, according to the present disclosure. As shown in FIG. 6, a first filter panel 192 and a second filter panel 196 have been removed from the MPF 104 in a downstream direction 200. The filter panels 192, 196 can be slid out of the MPF 104 after disengaging the pleat channel 204 from the top and bottom end plates 140, 144 and removed in the downstream direction 200. Any of various devices, mechanisms, and/or hardware may be used to couple the pleat channel 204 with the top and bottom end plates 140, 144. Once the pleat channel 204 has been removed from the top and bottom end plates 140, 144, the first filter panel 192 can be slid out of seats 208 and 212 that are respectively disposed in the top and bottom end plates 140, 144. Similarly, the second filter panel 196 can be slid out of seats 216 and 220 that are respectively disposed in the top and bottom end plates 140, 144. Thus, the MPF 104 can be left installed in the HVAC system 108 while individual dirty filter panels 192, 196 are removed for servicing.

FIG. 7 illustrates an exemplary-use environment wherein dirty filter panels have been removed from an upstream side of the MPF 104 for cleaning in accordance with the present disclosure. More specifically, a pleat channel 224 has been disengaged from the MPF 104 and first filter panel 228 and a second filter panel 232 have been removed from the MPF 104 in an upstream direction 236. As mentioned above, the pleat channel 224 may be coupled with the top and bottom end plates 140, 144 by way of any of various devices, mechanisms, and/or hardware that enables a practitioner to disassemble the pleat channel 224 from the MPF 104. Once the pleat channel 224 has been removed from the top and bottom end plates 140, 144, the first filter panel 228 can be slid out of seats 240 and 244 that are respectively disposed in the top and bottom end plates 140, 144. Similarly, the second filter panel 232 can be slid out of seats 248 and 252 that are respectively disposed in the top and bottom end plates 140, 144. As such, the MPF 104 can be left installed in the HVAC system 108 while individual dirty filter panels 228, 232 are removed for servicing.

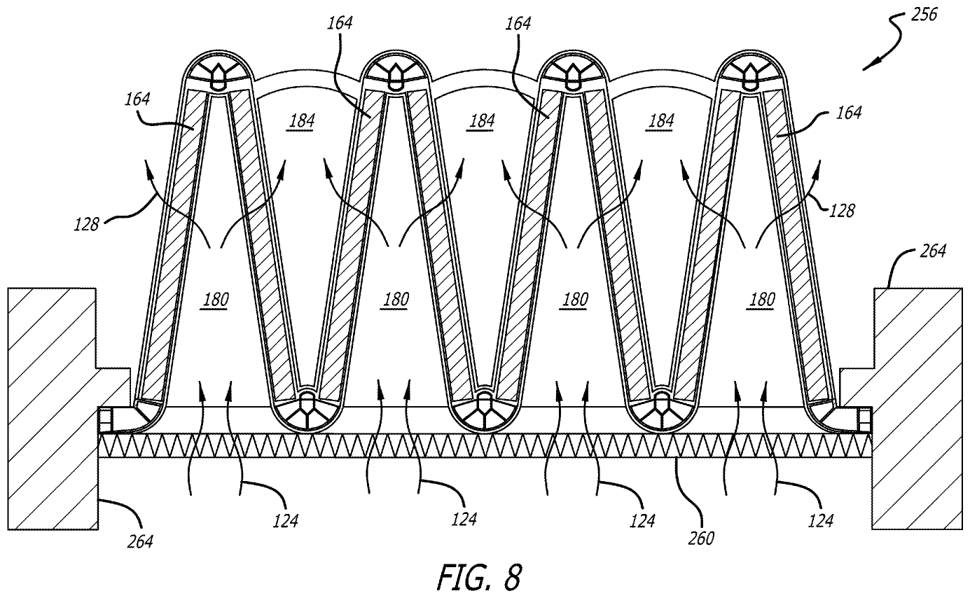

Turning, now, to FIG. 8, a cross-sectional view of an exemplary embodiment of an MPF 256 is shown coupled with an upstream, panel air filter 260, according to the present disclosure. The MPF 256 shown in FIG. 8 is substantially identical to the MPF 104 shown in FIGS. 3-7. In the embodiment illustrated in FIG. 8, a return airstream 124 flows through the panel air filter 260 before entering upstream volumes 180 of the MPF 256. As such, upon the return airstream 124 passing through filter panels 164 comprising the MPF 256, a clean airstream 128 exits the MPF 256 through downstream volumes 184 of the MPF 256.

In the embodiment illustrated in FIG. 8, the return airstream 124 flows through the panel air filter 260 before passing through the MPF 256. As such, the panel air filter 260 comprises a primary filter 260 while the MPF 256 comprises a secondary filter 256. It is contemplated that primary filter 260 can be used to remove a relatively large portion of the contaminants and VOCs flowing with the return airstream 124 so as to extend the longevity of the secondary filter 256. In some embodiments, the primary filter 260 may have a lower MERV rating than the MERV rating of the secondary filter 256. Since the cost of air filters is generally proportional to their MERV ratings, it is cost effective to replace or service the primary filter 260 more frequently than the secondary filter 256. In some embodiments, wherein the filters 256, 260 are configured to be reused, the primary filter 260 can be removed from the HVAC system 108 and cleaned with greater ease than removing and cleaning the secondary filter 256. As such, including the primary filter 260 discourages practitioners from putting off timely service intervals due to a perceived complexity of frequently servicing the secondary filter 256.

As shown in FIG. 8, the filters 256, 260 are supported by way of structures 264. It should be understood that structures 264 comprise portions disposed in the HVAC system 108 that are configured for supporting at least the secondary filter 256. In some embodiments, therefore, the primary filter 260 can be incorporated into the secondary filter 256. Thus, the primary filter 260 can be a removable portion of the secondary filter 256. For example, the primary filter 260 may be coupled with the secondary filter 256 by way of a hinge and a clasp (not shown). In such embodiments, the primary filter 260 may be removed from the second filter 256 by unfastening the clasp and then rotating the primary filter 260 away from the secondary filter 256 in a manner that resembles opening a door. Thus, the primary filter 260 may be uninstalled from the secondary filter 256 without the entire secondary filter 256 having to be removed from the structures 264. As such, the primary filter 260 can be easily removed, cleaned, and reinstalled into the HVAC system 108 to preserve the operating efficiency of the HVAC system 108.

In some embodiments, wherein the primary filter 260 includes a filter oil composition, a solvent may be used to remove the filter oil from the primary filter 260. Once the primary filter 260 has sufficiently dried, a suitably formulated filter oil composition may be applied and allowed to wick into the primary filter 260. The primary filter 260 may then be reinstalled into secondary filter 256 within the HVAC system 108. Various other cleaning methods will be apparent to those skilled in the art without deviating from the spirit and scope of the present disclosure.

In some embodiments, either or both of the filters 256, 260 may be configured to detect a pressure differential across the filter, due to contaminant buildup, and indicate when the filter needs to be serviced. For example, in some embodiments, the primary filter 260 can include a filter medium supported within a frame and a differential pressure detector incorporated into the frame. The differential pressure detector can signal when the pressure differential across the primary filter 260 reaches a threshold value due to contaminant buildup within the filter medium. The differential pressure detector can include circuitry that wirelessly signals an application stored on a mobile device to display a notification when the primary filter 260 needs to be cleaned or replaced to minimize energy consumption by the HVAC system 108. Further details pertaining to incorporating differential pressure detectors into air filters may be found in U.S. Provisional Application, entitled “Air Filter System For Detecting A Pressure Differential To Indicate A Need For Servicing,” filed on Dec. 12, 2023, and having application Ser. No. 63/609,110, the entirety of which application is incorporated herein by reference and made a part of the present disclosure.

In some embodiments, either or both of the filters 256, 260 may be configured to detect mechanical strain on the filter, due to contaminant buildup, and indicate when the filter needs to be serviced. In one embodiment, for example, the primary filter 260 comprises a filter medium supported within a frame and a mechanical strain detector incorporated into the frame. The mechanical strain detector signals when the force acting on the primary filter 260 reaches a threshold value due to contaminant buildup within the filter medium. The mechanical strain detector includes circuitry that wirelessly signals an application stored on a mobile device to display a notification when the primary filter 260 needs to be cleaned or replaced to minimize energy consumption by the HVAC system 108. Further details pertaining to air filters configured to detect mechanical strain can be found in U.S. Provisional Application, entitled “Air Filter System For Detecting Mechanical Strain To Indicate A Need For Servicing,” filed on Dec. 12, 2023, and having application Ser. No. 63/609,280, the entirety of which application is incorporated herein by reference and made a part of the present disclosure.

In some embodiments, either or both of the filters 256, 260 may be configured to detect a temperature differential across the filter, due to contaminant buildup, and indicate when the filter needs to be serviced. In an exemplary embodiment, the primary filter 260 comprises a filter medium supported within a frame and a differential temperature sensor incorporated into the frame. The differential temperature sensor signals when air pressure across the air filter reaches a threshold value due to contaminant buildup within the filter medium. The differential temperature sensor includes circuitry that wirelessly signals an application stored on a mobile device to display a notification when the primary filter 260 needs to be cleaned or replaced to minimize energy consumption by the HVAC system 108. Further details pertaining to air filters configured to detect a temperature differential can be found in U.S. Provisional Application, entitled “Air Filter System For Detecting A Temperature Differential To Indicate A Need For Servicing,” filed on Dec. 12, 2023, and having application Ser. No. 63/609,285, the entirety of which application is incorporated herein by reference and made a part of the present disclosure.

In some embodiments, either or both of the filters 256, 260 may be configured to detect changes in electrical properties of electrodes in the filter and determine a corresponding pressure differential across the filter, due to contaminant buildup, to indicate when the filter needs to be serviced. In some embodiments, the primary filter 260 can include a filter medium supported within a frame and a differential electrical properties detector incorporated into the frame. The differential electrical properties detector can signal when air pressure across the primary filter 260 reaches a threshold value due to contaminant buildup within the filter medium. The differential electrical properties detector can include circuitry that wirelessly signals an application stored on a mobile device to display a notification when the primary filter 260 needs to be cleaned or replaced to minimize energy consumption by the HVAC system 108. Further details pertaining to air filters configured to detect differential electrical properties can be found in U.S. Provisional Application, entitled “Air Filter System For Detecting Differential Electrical Properties To Indicate A Need For Servicing,” filed on Dec. 14, 2023, and having application Ser. No. 63/610,029, the entirety of which application is incorporated herein by reference and made a part of the present disclosure.

In some embodiments, either or both of the filters 256, 260 may be configured to detect changes in optical properties of the filter and determine a corresponding pressure differential across the filter, due to contaminant buildup, to indicate when the filter needs to be serviced. For example, in some embodiments, primary filter 260 comprises a filter medium supported within a frame and a differential optical properties detector incorporated into the frame. The differential optical properties detector signals when air pressure across the primary filter 260 reaches a threshold value due to contaminant buildup within the filter medium. The differential optical properties detector includes circuitry that wirelessly signals an application stored on a mobile device to display a notification when the primary filter 260 needs to be cleaned or replaced to minimize energy consumption by the HVAC system 108. Further details pertaining to air filters configured to detect differential optical properties can be found in U.S. Provisional Application, entitled “Air Filter System For Detecting Differential Optical Properties To Indicate A Need For Servicing,” filed on Dec. 14, 2023, and having application Ser. No. 63/610,076, the entirety of which application is incorporated herein by reference and made a part of the present disclosure.

In some embodiments, either or both of the filters 256, 260 may be configured to detect passive vibrations of the filter, due to contaminant buildup, and indicate when the filter needs to be serviced. For example, in some embodiments, the primary filter 260 may comprise a filter medium supported within a frame and a resonant characteristics detector incorporated into the frame. The resonant characteristics detector may be configured to signal when the force acting on the primary filter 260 reaches a threshold value due to contaminant buildup within the filter medium. The resonant characteristics detector may include circuitry that wirelessly signals an application stored on a mobile device to display a notification when the primary filter 260 needs to be cleaned or replaced to minimize energy consumption by the HVAC system 108. Further details pertaining to air filters configured to detect air filter vibration differences can be found in U.S. Provisional Application, entitled “Air Filter Vibration Differences To Indicate Contaminant Buildup,” filed on Dec. 14, 2023, and having application Ser. No. 63/610,056, the entirety of which application is incorporated herein by reference and made a part of the present disclosure.

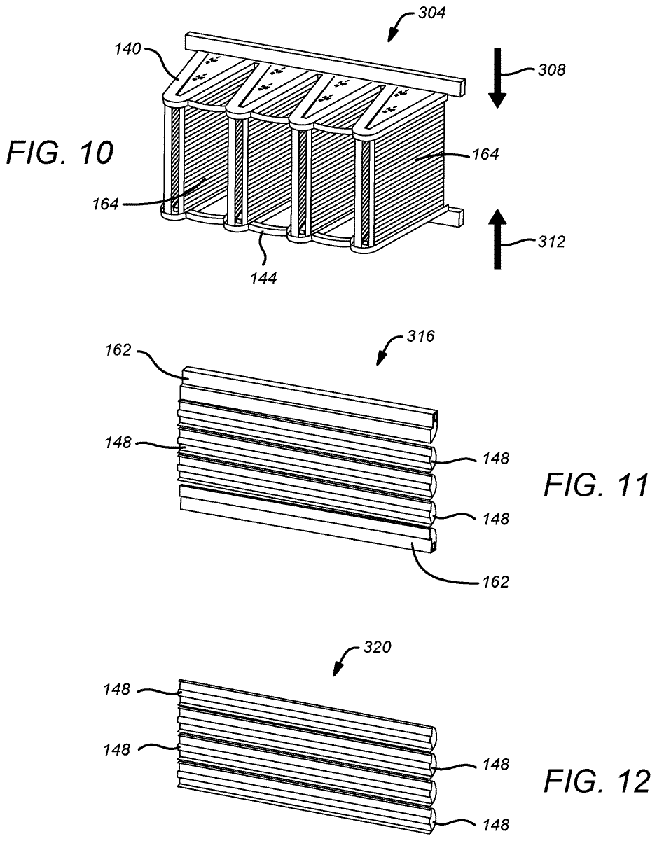

Turning, now, to FIG. 10, an exemplary embodiment of a modular multi-panel air filter 304 (hereinafter, “MPF 304”) that is configured to be compressed for shipping is shown. As will be appreciated, the MPF 104 shown in FIG. 3 generally is a large, bulky item that can be costly from a shipping standpoint. As such, there is a continuous desire to reduce the overall size of the MPF 104 to reduce required storage space and shipping costs. The MPF 304 of FIG. 10 fulfills this desire by being compressible into a relatively small volume for shipping and then being easily expandable by an end-user, or a customer, upon receiving the MPF 304. As shown in FIG. 10, the MPF 304 can be compressed by moving a top end plate 140 of the MPF 304 along a downward direction 308 while also moving a bottom end plate 144 of the MPF 304 along an upward direction 312, thereby collapsing the pleats comprising the filter panels 164.

It is contemplated that the compressed configuration of the MPF 304, shown in FIG. 10, can be secured by straps, tape, twine, or a similar device, or any combination thereof until being expanded by a customer receiving the MPF 304. Further, FIG. 11 illustrates an exemplary embodiment of a packaging configuration 316 for upstream vertical members comprising the MPF 304. The packaging configuration 316 comprises a vertical arrangement of pleat channels 148 and side rails 162 that are to be disposed on an upstream side of the MPF 304, as shown with respect to the MPF 104 in FIG. 3. FIG. 12 illustrates an exemplary embodiment of a packaging configuration 320 for downstream vertical members comprising the MPF 304. The packaging configuration 320 comprises a vertical arrangement of pleat channels 148 that are to be disposed on a downstream side of the MPF 304, as shown in connection with the MPF 104 in FIG. 3.

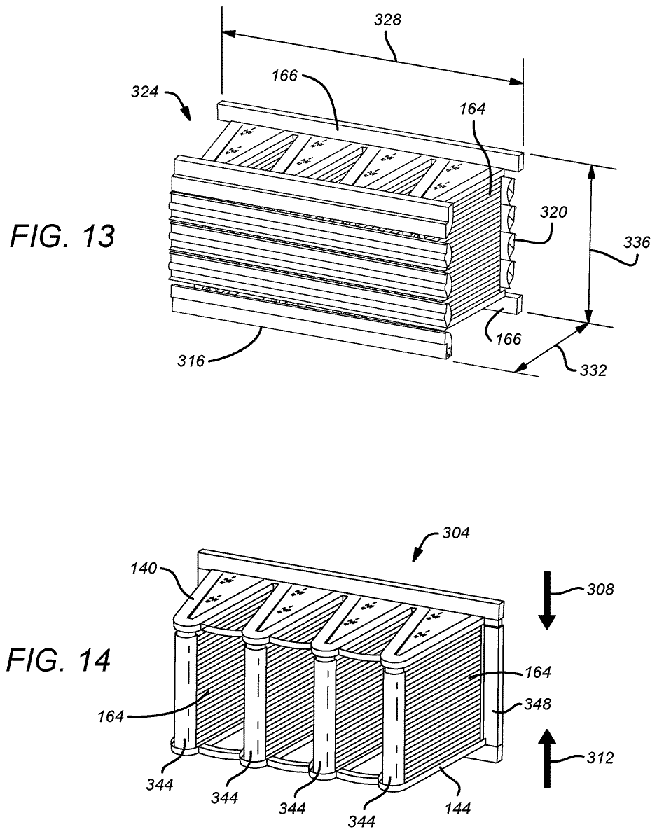

FIG. 13 illustrates an exemplary embodiment of a packaging configuration 324 of the MPF 304 and the vertical members shown in FIGS. 11-12 in accordance with the present disclosure. As shown in FIG. 13, the MPF 304 is compressed, as discussed with respect to FIG. 10. The packaging configuration 320 of pleat channels 148, shown in FIG. 12, is then positioned between a ledge 166 of the top end plate 140 and a ledge 166 of the bottom end plate 144, while the packaging configuration 316 of the pleat channels 148 and side rails 162 is positioned in front of a downstream side of the MPF 304. As shown in FIG. 13, the packaging configuration 324 gives the MPF 304 a shipping length 328, a shipping depth 332, and a shipping height 336. Although the shipping length 328 and the shipping depth 332 are substantially similar to the length and depth of the MPF 104, shown in FIG. 3, the shipping height 336 is much smaller than the height of the MPF 104. It is contemplated that the reduced volume of the MPF 304 will result in significantly lower storage and shipping costs.

Upon receiving the MPF 304, the end-user or customer can unbox and assemble the MPF 304. As will be appreciated, the MPF 304 can be expanded by pulling the top end plate 140 in the upward direction 312 and pulling the bottom end plate 144 in the downward direction 308 so as to advantageously stretch open the pleats of the filter panels 164. Once the MPF 304 is expanded to the size shown in FIG. 3, the pleat channels 148 and the side rails 162 comprising the packaging configuration 316 (see FIG. 11) can be installed on the upstream side of the MPF 304, between the top end plate 140 and the bottom end plate 144. The pleat channels 148 comprising the packaging configuration 320 (see FIG. 12) can be installed on the downstream side of the MPF 304, between the top end plate 140 and the bottom end plate 144. The MPF 304 can then be installed into the HVAC system 108, as described herein.

FIG. 14 illustrates an exemplary embodiment of a modular multi-panel air filter 340 (hereinafter, “MPF 340”) that is configured to be compressed for storage and shipping. The MPF 340 shown in FIG. 14 is substantially similar to the MPF 304 shown in FIG. 10, with the exception that the MPF 340 comprises multiple telescoping pleat channels 344 and a pair of telescoping side rails 348. In general, each of the telescoping pleat channels 344 and telescoping side rails 348 comprises concentric tubular parts configured to slide into itself, so that it becomes smaller when a top end plate 140 is moved along a downward direction 308 while a bottom end plate 144 is moved along an upward direction 312. It is contemplated that the compressed configuration of the MPF 340, shown in FIG. 14, can be secured by straps, tape, twine, or a similar device, or any combination thereof until being expanded by a customer receiving the MPF 340.

As will be appreciated, shortening the telescoping pleat channels 344 and the telescoping side rails 348 enables compressing the MPF 340 without having to additionally rely upon the packaging configuration 316 for the upstream vertical members and the packaging configuration 320 for downstream vertical members described in connection with FIGS. 11-13. Thus, upon receiving the MPF 340, the end-user or customer can unbox and assemble the MPF 340 by pulling the top end plate 140 in the upward direction 312 and pulling the bottom end plate 144 in the downward direction 308 so as to increase the length of the telescoping pleat channels 344 and the telescoping side rails 348 and stretch open the pleats of the filter panels 164. It is contemplated that the telescoping pleat channels 344 and the telescoping side rails 348 are configured to advantageously lock at a length that maintains an operational configuration of the MPF 340, as best shown FIG. 3 in connection with the MPF 104. The MPF 340 can then be installed into the HVAC system 108, as described herein.

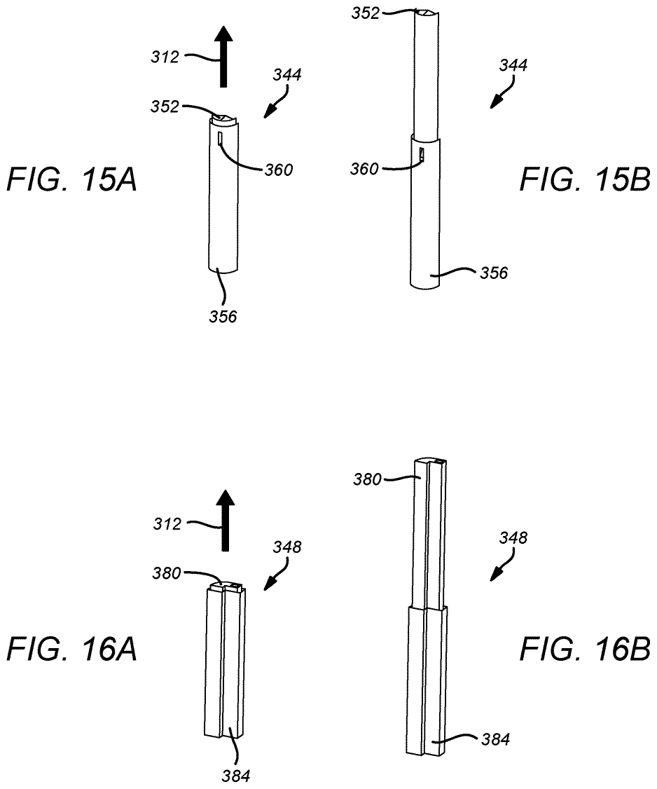

FIG. 15 illustrate an exemplary embodiment of a telescoping pleat channel 344 that can be incorporated into the MPF 340 shown in FIG. 14. FIG. 15A illustrates the telescoping pleat channel 344 in a compressed configuration while FIG. 15B illustrates the telescoping pleat channel 344 in an extended configuration. The telescoping pleat channel 344 comprises an upper portion 352 that is concentric with a bottom portion 356. Thus, in the compressed configuration, the upper portion 352 can slide nearly completely into an interior of the bottom portion 356. The telescoping pleat channel 344 can be changed from the compressed configuration to the extended configuration by pulling the upper portion 352 along an upward direction 312 until a lock 360 engages and fixates the extended configuration of the telescoping pleat channel 344.

FIG. 15C illustrates a close-up cross-sectional view of an exemplary embodiment of a lock 360 that is configured to fixate the extended configuration of the telescoping pleat channel 344. In general, the lock 360 comprises a protrusion 364 disposed on the upper portion 352 that can be captured in a window 368 in the bottom portion 356. The protrusion 364 includes a right-angled surface 372 and a sloped surface 376. Once the protrusion 364 snaps into the window 368, due to the upper portion 352 being pulled upward with respect to the bottom portion 356, the right-angled surface 372 prevents the upper portion 352 from sliding downward inside the bottom portion 356. Thus, the right-angled surface 372 and window 368 serve to maintain the extended configuration of the telescoping pleat channel 344 shown in FIG. 15B. It should be borne in mind that the lock 360 illustrated and described herein is purely exemplary in nature, and that many variations of the lock 360 as well as many other mechanisms whereby the extended configuration of the telescoping pleat channel 344 can be maintained are contemplated within the spirit and scope of the present disclosure.

FIG. 16 illustrate an exemplary embodiment of a telescoping side rail 348 that can be incorporated into the MPF 340 shown in FIG. 14. FIG. 16A illustrates the telescoping side rail 348 in a compressed configuration while FIG. 16B illustrates the telescoping side rail 348 in an extended configuration. The telescoping side rail 348 comprises an upper portion 380 that is concentric with a bottom portion 384. Thus, in the compressed configuration, the upper portion 380 can slide nearly completely into an interior of the bottom portion 384. The telescoping side rail 348 can be changed from the compressed configuration to the extended configuration by pulling the upper portion 380 along an upward direction 312 until a lock, such as the lock 360 shown in FIG. 15C, engages and fixates the extended configuration of the telescoping side rail 348. It is contemplated that the lock 360 can be disposed in any of various locations of the telescoping side rail 348, without deviating beyond the spirit and scope of the present disclosure.

While the reusable modular multi-panel air filter and methods have been described in terms of particular variations and illustrative figures, those of ordinary skill in the art will recognize that the reusable modular multi-panel air filter is not limited to the variations or figures described. In addition, where methods and steps described above indicate certain events occurring in certain order, those of ordinary skill in the art will recognize that the ordering of certain steps may be modified and that such modifications are in accordance with the variations of the reusable modular multi-panel air filter. Additionally, certain of the steps may be performed concurrently in a parallel process, when possible, as well as performed sequentially as described above. To the extent there are variations of the reusable modular multi-panel air filter, which are within the spirit of the disclosure or equivalent to the reusable modular multi-panel air filter found in the claims, it is the intent that this patent will cover those variations as well. Therefore, the present disclosure is to be understood as not limited by the specific embodiments described herein, but only by scope of the appended claims.

What is claimed is:

1. A reusable multi-panel air filter for an HVAC system of a building, comprising:
a multiplicity of reusable filter panels arranged into a V-bank filter element for filtering an airstream;
a top end plate supporting top edges of the filter panels;
a bottom end plate supporting bottom edges of the filter panels;
a telescoping pleat channel supporting adjacent side edges of the filter panels; and
a telescoping side rail supporting opposite ends of the top end plate and the bottom end plate.

2. The reusable multi-panel air filter of claim 1, wherein the telescoping pleat channels and the telescoping side rails are configured to shorten when the top end plate and the bottom end plate are pressed toward one another, thereby decreasing a height dimension of the V-bank filter element.

3. The reusable multi-panel air filter of claim 2, wherein the filter panels include pleats that are configured to collapse when the top end plate and the bottom end plate are pressed toward one another, thereby decreasing the height dimension of the V-bank filter element.

4. The reusable multi-panel air filter of claim 1, wherein the telescoping pleat channels and the telescoping side rails are configured to enable compressing the V-bank filter element into a smaller volume to reduce storage and shipping costs.

5. The reusable multi-panel air filter of claim 1, wherein the telescoping pleat channels and the telescoping side rails are configured to enable expanding the V-bank filter element from a compressed configuration by pulling the top end plate and the bottom end plate in opposite directions to increase the lengths of the telescoping pleat channels and the telescoping side rails and stretch open pleats of the filter panels.

6. The reusable multi-panel air filter of claim 5, wherein the telescoping pleat channels and the telescoping side rails are configured to lock at lengths that maintain an operational configuration of the V-bank filter element.

7. The reusable multi-panel air filter of claim 1, wherein the telescoping pleat channel is configured to be changed from a compressed configuration to an extended configuration.

8. The reusable multi-panel air filter of claim 7, wherein the telescoping pleat channel comprises at least one upper portion that is concentric with at least one bottom portion.

9. The reusable multi-panel air filter of claim 8, wherein the upper portion is configured to slide within an interior of the bottom portion.

10. The reusable multi-panel air filter of claim 9, wherein the telescoping pleat channel includes a lock configured to fixate the extended configuration of the telescoping pleat channel.

11. The reusable multi-panel air filter of claim 10, wherein the extended configuration comprises a length of the telescoping pleat channel that maintains an operational configuration of the V-bank filter element.

12. The reusable multi-panel air filter of claim 11, wherein the telescoping pleat channel is configured to be changed from the compressed configuration to the extended configuration by pulling the upper portion out of the interior of the bottom portion until the lock engages and fixates the extended configuration of the telescoping pleat channel.

13. The reusable multi-panel air filter of claim 1, wherein the telescoping side rail is configured to be changed from a compressed configuration to an extended configuration.

14. The reusable multi-panel air filter of claim 13, wherein the telescoping side rail comprises at least one upper portion that is concentric with at least one bottom portion.

15. The reusable multi-panel air filter of claim 14, wherein the upper portion is configured to slide within an interior of the bottom portion.

16. The reusable multi-panel air filter of claim 15, wherein the telescoping side rail includes a lock configured to fixate the extended configuration of the telescoping side rail.

17. The reusable multi-panel air filter of claim 16, wherein the extended configuration comprises a length of the telescoping side rail that maintains an operational configuration of the V-bank filter element.

18. The reusable multi-panel air filter of claim 17, wherein the telescoping side rail is configured to be changed from the compressed configuration to the extended configuration by pulling the upper portion out of the interior until the lock engages and fixates the extended configuration of the telescoping side rail.
